(19) United States
(12) Patent Application Publication
(10) Pub. No.: US 2004/0130635 A1
(43) Pub. Date: Jul. 8, 2004

(54) Image processing apparatus and image processing method

(75) Inventor: Yasushi Kasai, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/680,094

(22) Filed: Oct. 8, 2003

(30) Foreign Application Priority Data
Oct. 9, 2002 (JP) 2002-296122 (PAT.
Oct. 1, 2003 (JP) 2003-342958 (PAT.

(51) Int. Cl. H04N 5/262

(52) U.S. Cl. 348/231.99

(57) ABSTRACT

An image processing apparatus for making the usability of an image display function (also called as a slide show or AutoPlay) for reproducing a still image and a moving image in a removable medium (such as a memory card) at every predetermined reproduction time (display time) is provided. The apparatus includes a recording and reproducing unit for starting the reproduction of the initial part (for example, a sheet of the still image, the moving image for a reproduction time, or the like) of the moving image selected by a main control unit. When a reproduction button is depressed before the reproduction time T (for example, three seconds) from the start of the reproduction of a part of the moving image elapses, the recording and reproducing unit also reproduces the remaining part of the moving image selected by the main control unit. Thereby, a desired moving image can be viewed to the end thereof only by depressing the reproduction button B4 even when the slide show is being performed.

### BACKGROUND OF THE INVENTION

1. Field of the Invention

The present invention relates to an image processing apparatus and the like which has an image display function for displaying continuously a still image and a moving image recorded on a removable medium (for example, a memory card).

2. Related Background Art

A recent digital camera includes an image display function called as a slide show (or AutoPlay). This function is a function for reproducing automatically a still image and a moving image stored in a memory card at every predetermined reproduction time (also called as a display time, which is also applied in the following descriptions) to display the reproduced images on a liquid crystal display (LCD) or the like.

However, because the reproduction time of the conventional slide show of a digital camera is fixed, there is the case where only a part of a moving image can be reproduced. That is, when a recording time of a moving image is longer than the reduction time, only the initial part of the moving image can be displayed on the LCD. Consequently, when a user wants to view a desired moving image up to the end thereof during the slide show, it is impossible.

### SUMMARY OF THE INVENTION

An object of the present invention is to overcome the above-described drawbacks.

Another object of the present invention is to improve the usability of an image display function (the so-called slide show) for displaying continuously a still image and a moving image stored in a removable medium (such as a memory card).

An image processing apparatus according to one of the preferred embodiments of the present invention has a function of reproducing automatically a still image and a part of a moving image at every predetermined reproduction time and comprises reproducing means for reproducing the remaining part of the moving image when reproduction of the moving image is instructed while the part of the moving image is being reproduced.

An image processing method according to one of the preferred embodiments of the present invention comprises the steps of: reproducing automatically a still image and a part of a moving image at every predetermined reproduction time; and reproducing also the remaining part of the moving image when reproduction of the moving image is instructed while the part of the moving image is being reproduced.

A recording medium according to one of preferred embodiments of the present invention records thereon a program for executing an image processing method, the image processing method comprising the steps of: reproducing automatically a still image and a part of a moving image at every predetermined reproduction time; and reproducing also a remaining part of the moving image when reproduction of the moving image is instructed while a part of the moving image is being reproduced.

Still other objects, features and advantages of the present invention will become fully apparent from the following detailed description of the preferred embodiments.

### BRIEF DESCRIPTION OF THE DRAWINGS

FIG. 1 is a diagram illustrating the principal configuration of an image pickup apparatus 10 of a first embodiment;

FIG. 2 is a flowchart showing a part of a processing procedure of the slide show in the first embodiment;

FIG. 3 is a flowchart showing the other part of the processing procedure of the slide show in the first embodiment;

FIG. 4 is a diagram showing examples of folders and files to be stored by a removable memory 104;

FIG. 5 is a diagram illustrating the principal configuration of an image pickup apparatus 50 of a second embodiment;

FIG. 6 is comprised of FIG. 6A and FIG. 6B, which is a flowchart showing a processing procedure of the slide show in the second embodiment;

FIG. 7 is a diagram showing examples of a menu screen for a reproduction mode and a menu screen for the slide show;

FIG. 8 is a diagram showing examples of folders and files stored in a memory card 70.

### DESCRIPTION OF THE PREFERRED EMBODIMENTS

### First Embodiment

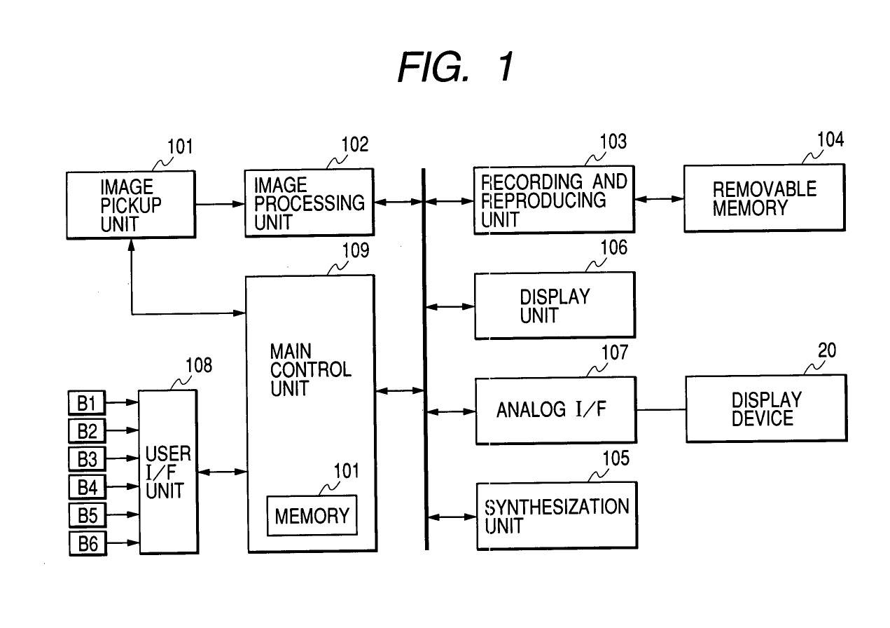

In the following, FIGS. 1 to 4 are referred to while a first embodiment suitable for the present invention is described.

FIG. 1 is a diagram illustrating the principal configuration of an image pickup apparatus 10 of the first embodiment. The image pickup apparatus 10 of the first embodiment is an apparatus having the slide show which is a function of reproducing automatically a still image and a part of a moving image stored in a storage medium or included in a group (for example, a folder) at every predetermined reproduction time. Moreover, the image pickup apparatus 10 of the first embodiment is an apparatus such as a digital camera, a digital video camera or the like.

In FIG. 1, an image pickup unit 101 is a unit for photographing a still image or a moving image by the use of an image sensor or the like. An image processing unit 102 is a unit for adjusting the image quality and the like of the still image or the moving image which is photographed by the image pickup unit 101.

A recording and reproducing unit 103 is a unit for recording the still image or the moving image obtained from the image processing unit 102 onto a removable memory 104. The recording and reproducing unit 103 is also a unit for reproducing the still image or the moving image selected by a main control unit 109 from the removable memory 104.

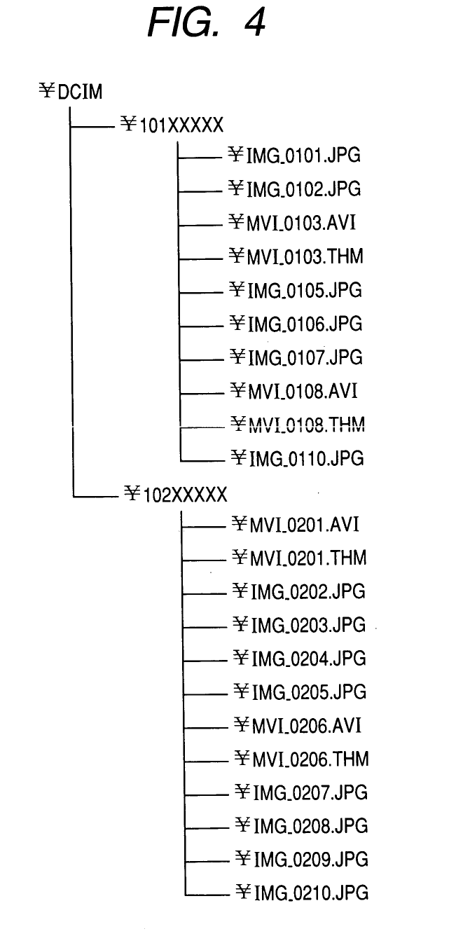

The removable memory 104 is a detachable storage medium for storing a moving image and a still image. Moreover, the removable memory 104 is also a storage medium to which random accessing can be preformed. A memory card is a storage medium corresponding to the removable memory 104. Examples of folders and files to be stored onto the removable memory 104 are shown in FIG. 4. In FIG. 4, “DCIM,” “101XXXXX” and “102XXXXX” are folders. “IMG_{—}0101.JPG,” “IMG_{—}0102.JPG,” “IMG_{—}0105.JPG” to “IMG_{—}0107.JPG,” “IMG_{—}0110.JPG,” “IMG_{—}0202.JPG” to “IMG_{—}0205.JPG,” and “IMG_{—}0207.JPG” to “IMG_{—}0210.JPG” are still images. “MVI_{—}0103.AVI,” “MVI_{—}0108.AVI,” “MVI_{—}0201.AVI” and “MVI_{—}0206.AVI” are moving images. “MVI_{—}0103.THM,” “MVI_{—}0108.THM,” “MVI_{—}0201.THM” and “MVI_{—}0206.THM” are thumbnail images corresponding to “MVI_{—}0103.AVI,” “MVI_{—}0108.AVI,” “MVI_{—}0201.AVI” and “MVI_{—}0206.AVI.”

A synthesization unit 105 is a unit for synthesizing (or superimposing) the auxiliary information of a still image or a moving image reproduced by the recording and reproducing unit 103 with the still image or the moving image.

A display unit 106 is a unit for displaying a still image or a moving image obtained from the synthesization unit 105. An analog interface unit 107 is a unit for converting a still image or a moving image obtained from the synthesization unit 105 to an analog video signal and for outputting the analog video signal to the outside.

A user interface unit 108 is a unit for informing the main control unit 109 of an instruction from a user. The user interface unit 108 includes a shutter button B1, a moving image/still image button B2, a slide show button B3, a reproduction button B4, a stop button B5, a reproduction time button B6 and the like. The shutter button B1 is a button for instructing an image pickup of a still image or a moving image. The moving image/still image button B2 is a button for selecting a still image pickup mode for performing the image pickup of a still image or a moving image pickup mode for performing the image pickup of a moving image. The slide show button B3 is a button for instructing a start or a stop of the slide show in the first embodiment. The reproduction button B4 is a button for instructing the reproduction of a still image or a moving image. The stop button B5 is a button for instructing a stop of the reproduction of a still image or a moving image. The reproduction time button B6 is a button for changing the reproduction time T of a still image or a moving image to, for example, three seconds, five seconds, seven seconds or the like.

The main control unit 109 is a unit for controlling various functions of the image pickup apparatus 10. The slide show in the first embodiment is also a function controlled by the main control unit 109. Incidentally, the main control unit 109 of the first embodiment is arranged to control the slide show in the first embodiment in accordance with a program held by the program memory 110.

A display device 20 is a device which is connectable to the analog interface unit 107, and displays an analog video signal output from the analog interface unit 107.

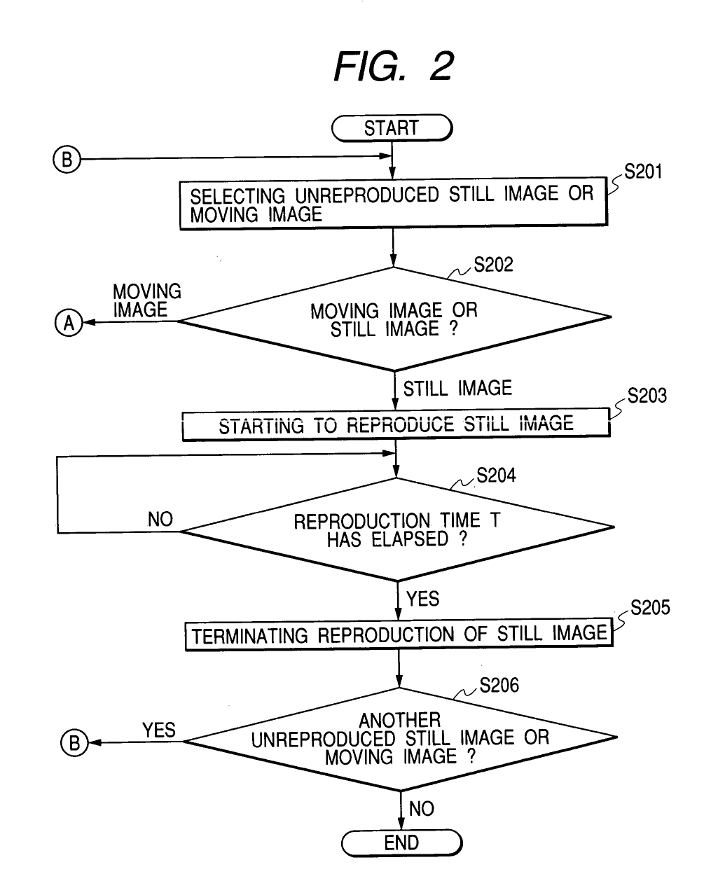

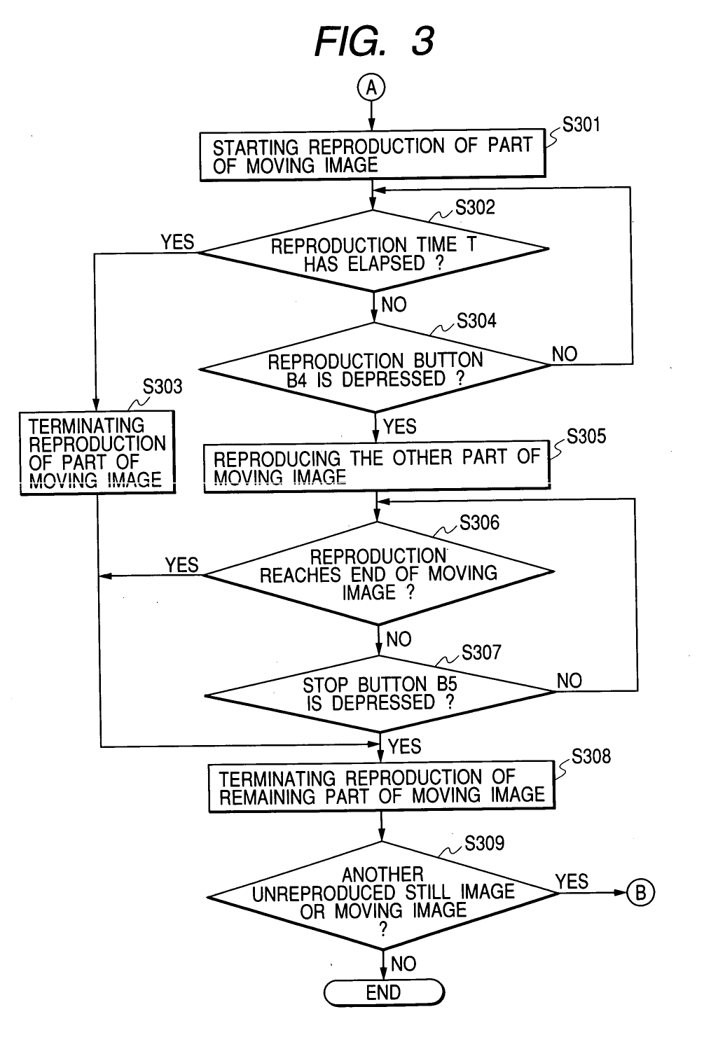

FIGS. 2 and 3 are flowcharts showing a processing procedure of the slide show in the first embodiment.

At Step S201, the main control unit 109 selects an unreproduced still image or a moving image in the removable memory 104 (or in a folder specified by a user) in accordance with a predetermined selection condition (for example, the order of file names).

At Step S202, when the main control unit 109 selects a moving image, the main control unit 109 proceeds to Step S301. When the main control unit 109 selects a still image, the main control unit 109 proceeds to Step S203.

At Step S203, the recoding and reproducing unit 103 starts to reproduce the still image selected by the main control unit 109. The synthesization unit 105 synthesizes (or superimposes) the auxiliary information (including the file name, the image size, the total number of reproduced still images and moving images, the total number of the still images and the moving images in the removable memory 104, a mark indicating that the image is a still image, and the like) of the still image reproduced by the recording and reproducing unit 103 with the still image. The display unit 106 displays a still image obtained from the synthesization unit 105. The analog interface unit 107 converts the still image obtained from the synthesization unit 105 to an analog video signal, and outputs the analog video signal to the outside. Thereby, the user can view the still image on any one of the display unit 106 and the display device 20.

At Step S204, the main control unit 109 judges whether a reproducing time T from the start of the reproduction of the still image (such as three seconds, five seconds, seven seconds or the like) has elapsed or not. When the reproduction time T has elapsed, the main control unit 109 proceeds to Step S205.

At Step S205, the recording and reproducing unit 103 terminates the reproduction of the still image selected by the main control unit 109.

At Step S206, the main control unit 109 judges whether any unreproduced still images or moving images exist on the removable memory 104 (or in the folder specified by the user) or not. When some unreproduced still images or moving images exist, the main control unit 109 proceeds to Step S201.

At Step S301, the recording and reproducing unit 103 starts to reproduce the initial part (for example, a sheet of a still image or a moving image for the reproduction time) of the moving image selected by the main control unit 109. The synthesization unit 105 synthesizes (or superimposes) the auxiliary information (including the file name, the image size, the total number of reproduced still images and moving images, the total number of the still images and the moving images in the removable memory 104, a mark indicating that the image is a moving image, and the like) of the moving image the initial part of which has been reproduced by the recording and reproducing unit 103, with the initial part of the moving image. The display unit 106 displays the initial part of the moving image obtained from the synthesization unit 105. The analog interface unit 107 converts the initial part of the moving image obtained from the synthesization unit 105 to an analog video signal, and outputs the converted analog video signal to the outside. Thereby, the user can view the initial part of the moving image on any one of the display unit 106 and the display device 20. Incidentally, although the image pickup apparatus 10 is configured to reproduce the initial part of the moving image at Step S301, it is also possible to be configured to reproduce other part of the moving image.

At Step S302, the main control unit 109 judges whether the reproducing time T from the start of the reproduction of the part of the moving image (such as three seconds, five seconds, seven seconds or the like) has elapsed or not. When the reproduction time T has elapsed, the main control unit 109 proceeds to Step S303. When the reproduction time T has not elapsed yet, the main control unit 109 proceeds to Step S304.

At Step S303, the recording and reproducing unit 103 terminates the reproduction of the part of the moving image selected by the main control unit 109.

At Step S304, the main control unit 109 judges whether the reproduction button B4 is depressed or not before the reproduction time T from the start of the reproduction of the part of the moving image by the recording and reproducing unit 103, elapses. When the reproduction button B4 is depressed, the main control unit 109 proceeds to Step S305. When the reproduction button B4 is not depressed yet, the main control unit 109 proceeds to Step 302.

At Step S305, the recording and reproducing unit 103 also reproduces the remaining part of the moving image selected by the main control unit 109. The synthesization unit 105 synthesizes (or superimposes) the auxiliary information (including the file name, the image size, the total number of reproduced still images and moving images, the total number of the still images and the moving images in the removable memory 104, a mark indicating that the image is a moving image, and the like) of the moving image the remaining part of which has been reproduced by the recording and reproducing unit 103, with the remaining part of the moving image. The display unit 106 displays the remaining part of the moving image obtained from the synthesization unit 105. The analog interface unit 107 converts the remaining part of the moving image obtained from the synthesization unit 105 to an analog video signal, and outputs the converted analog video signal to the outside. Thereby, the user can view the desired moving image up to the end thereof only by depressing the reproduction button B4 even when the slide show is being performed. Incidentally, although the image pickup apparatus 10 is configured to reproduce the remaining part of the moving image at Step S305, it is also possible to be configured to reproduce the moving image from the initial part thereof.

At Step S306, the main control unit 109 judges whether the moving image selected by the main control unit 109 has been reproduced up to the end thereof or not. When the reproduction reaches the end of the moving image, the main control unit 109 proceeds to Step S308. When the reproduction does not reach the end of the moving image, the main control unit 109 proceeds to Step S307.

At Step S307, the main control unit 109 judges whether the stop button B5 is depressed or not before the moving image selected by the main control unit 109 has been reproduced up to the end thereof. When the stop button B5 is depressed, the main control unit 109 proceeds to Step S308.

At Step S308, the recording and reproducing apparatus 103 terminates the reproduction of the remaining part of the moving image selected by the main control unit 109.

At Step S309, the main control unit 109 judges whether any undisplayed still images or moving images exist or not on the removable memory 104 (or in the folder specified by the user). When some undisplayed still images or moving images exist, the main control unit 109 proceeds to Step S201.

As described above, according to the image pickup apparatus 10 of the first embodiment, it is possible to select whether a desired moving image is reproduced up to the end thereof or not only by depressing the reproduction button B4 even when the slide show is being performed. Consequently, the usability of the slide show can be improved.

Moreover, according to the image pickup apparatus 10 of the first embodiment, even when a desired moving image is being reproduced up to the end thereof, the next still image or the moving image can be viewed only by depressing the stop button B5. Consequently, the usability of the slide show can be improved.

Incidentally, the present invention is not limited to the present embodiment described above, and can be implemented by various forms. For example, the application of the present invention is not limited to the image pickup apparatus, but the present invention may be applied to an image processing apparatus such as a video recorder or the like. Moreover, the present invention may be applied to a program, which a computer can execute.

### Second Embodiment

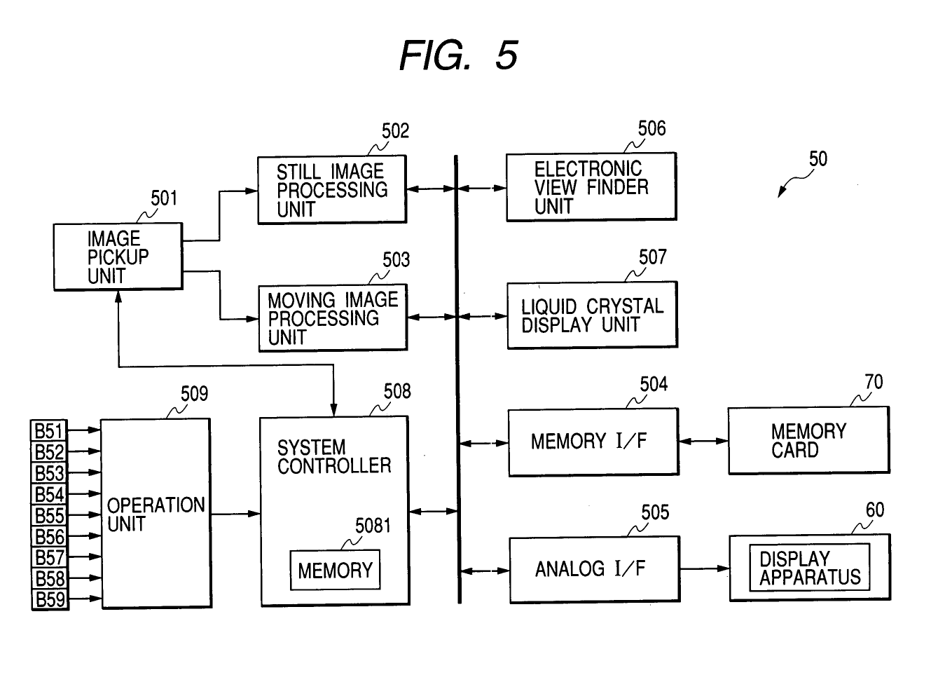

FIG. 5 is a diagram illustrating the principal components of an image pickup apparatus 50 of a second embodiment. The image pickup apparatus 50 shown in FIG. 5 is an apparatus such as a digital camera, a digital video camera, a portable telephone with a camera, a portable terminal with a camera, or the like.

In FIG. 5, a reference numeral 501 denotes an image pickup unit for converting an optical image into image data by means of image pickup devices (such as CCD sensors, CMOS sensors or the like). A reference numeral 502 denotes a still image processing unit having a function of generating an image file including still image data, in accordance with a predetermined format (such as JPEG, JPEG-2000 or the like) from the image data output from the image pickup unit 501. A reference numeral 503 denotes a moving image processing unit having a function of generating an image file including moving image data, in accordance with a predetermined format (such as Motion JPEG, MPEG-4 or the like) from the image data output from the image pickup unit 501. Incidentally, the moving image data may be moving image data with sounds or moving image data without sounds.

A reference numeral 504 denotes a memory card interface having a function of saving an image file output from the still image processing unit 502 or the moving image processing unit 503 into a memory card 70, and a function of reading out the image file (including still image data or moving image data) selected by the system controller 508, from the memory card 70. The reference numeral 70 denotes the memory card (also called as a removal medium) which can be randomly accessed and includes a removable storage medium.

A reference numeral 505 denotes an analog interface having a function of converting still image data output from the still image processing unit 502 into an analog video signal to output the converted analog video signal to the outside, and a function of converting the moving image data output from the moving image processing unit 503 into an analog video signal, and outputting the converted analog video signal to the outside. A reference numeral 60 denotes a display apparatus having a display for displaying the analog video signal output from the analog interface 505.

A reference numeral 506 denotes an electronic view finder unit (EVF unit) including an electronic view finder (EVF). A reference numeral 507 denotes a liquid crystal display unit (LCD unit) including a liquid crystal display (LCD). The size of the display screen of the LCD unit 507 is set to be larger than the size of the display screen of the EVF unit 506.

A reference numeral 508 denotes a system controller for controlling the operation of the image pickup apparatus 50. The system controller 508 includes a memory 5081 for storing a program, which can be executed by the system controller 508. The memory 5081 stores a program for controlling the slide show which is one of the image displaying functions of the second embodiment.

A reference numeral 509 denotes an operation unit for informing the system controller 508 of an instruction input by a user. The operation unit 509 includes a still image photographing button B51, a moving image photographing button B52, a mode changing button B53, a menu button B54, an up button B55, a down button B56, a right button B57, a left button B58, an OK button B59 and the like. The still image photographing button B51 is a button for instructing generation and saving of still image data. The moving image photographing button B52 is a button for instructing generation and saving of moving image data. The mode changing button B53 is a button for changing an operation mode of the image pickup apparatus 50 to a photography mode or a reproduction mode. The photography mode is an operation mode for executing generation and saving of still image data or moving image data. The reproduction mode is an operation mode for displaying an image file (including still image data or moving image data) recorded on the memory card 70 on the EVF unit 506, the LCD unit 507 and the display apparatus 60. The menu button B54 is a button for instructing display of a menu screen, and the like.

A reference numeral 510 denotes a memory for storing the settings related to a display image, a display direction, a display time and repeating.

When the system controller 508 detects that the still image photographing button B51 is depressed in the photography mode, the system controller 508 controls the image pickup apparatus 50 to execute generation and saving of still image data. In this case, the still image processing unit 502 generates an image file including still image data in accordance with a predetermined format on the basis of the image data output from the image pickup unit 501. The memory card interface 504 saves the image file generated by the still image processing unit 502 into the memory card 70.

When the system controller 508 detects that the moving image photographing button B52 is depressed in the photography mode, the system controller 508 controls the image pickup apparatus 50 to execute generation and saving of moving image data. In this case, the moving image processing unit 503 generates an image file including the moving image data in accordance with a predetermined format on the basis of the image data output from the image pickup unit 501. The memory card interface 504 saves the image file generated by the moving image processing unit 503 into the memory card 70.

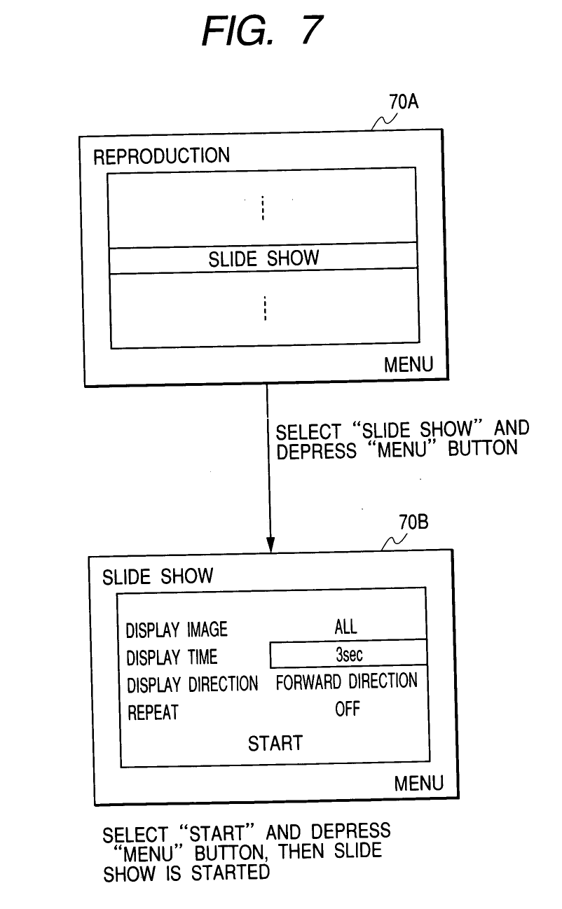

When the menu button B54 is depressed in the case where the operation mode of the image pickup apparatus 50 is the reproduction mode and in the case where the LCD unit 507 is on, the LCD unit 507 and the display apparatus 60 display a menu screen 70A (see FIG. 7) for the reproduction mode. When “Slide Show” in the menu screen 70A for the reproduction mode is selected and when the OK button B59 is depressed, the LCD unit 507 and the display apparatus 60 display a menu screen 70B (see FIG. 7) for the slide show.

By means of “Display Image” in the menu screen 70B, image data to be displayed in the slide show can be selected. When “All” is selected, that is, when a user operates the operation unit 509 to set “Display Image” to “All” as shown in FIG. 7, the LCD unit 507 or the display apparatus 60 displays continuously all of the image data saved in the memory cart 70. When “Folder” is selected, that is, when the user operates the operation unit 509 to set “Display Image” to “Folder” instead of “All,” the LCD unit 507 and the display apparatus 60 displays continuously all of the image data in the folder selected by the user. The settings related to displayed images are stored in the memory 510.

By means of “Display Time” in the menu screen 70B, a display time T (the period of time for displaying a piece of image data) can be selected. In the second embodiment, any of three seconds, five seconds, ten seconds, fifteen seconds, twenty seconds, twenty-five seconds and thirty seconds can be selected. The settings related to the display time T is stored in the memory 510.

By means of “Display Direction” in the menu screen 70B, the display direction of the slide show can be selected. When “Forward Direction” is selected, that is, when the user operates the operation unit 509 to set “Display Direction” to “Forward Direction” as shown in FIG. 7, the LCD unit 507 and the display apparatus 60 displays image data in the increasing order of folder names and the file names. When “Backward Direction” is selected, that is, when the user operates the operation unit 509 to set “Display Direction” to “Backward Direction” instead of “Forward Direction,” the LCD unit 507 and the display apparatus 60 displays image data in the decreasing order of folder names and the file names. The settings related to the display directions are stored in the memory 510.

By means of “Repeat” in the menu screen 70B, the validness or the invalidness of a repeat mode can be selected When the repeat mode is valid, the slide show is repeatedly executed until the menu button B54 is depressed. On the other hand, when the repeat mode is invalid, the slide show is terminated at the end of the first time thereof. When “On” is selected, that is, when the user operates the operation unit 509 to set “Repeat” to “On,” the system controller 508 makes the repeat mode valid. When “Off” is selected, that is, when the user operates the operation unit 509 to set “Repeat” to “Off” instead of “On” as shown in FIG. 7, the system controller 508 makes the repeat mode invalid. The settings related to the repeat operation are stored in the memory 510.

By means of “Start” in the menu screen 70B, the start of the slide show can be instructed. When the OK button B59 is depressed in the state in which “Start” is selected, the system controller 508 starts the slide show.

The image pickup apparatus 50 is portable equipment which can be driven by an AC source or by a battery. The image pickup apparatus 50 has a function for reducing the power consumption of the battery. In the function, when a user turns on the LCD unit 507, the image pickup apparatus 50 turns off the EVF unit 506, and when the user turns off the LCD unit 507, the image pickup apparatus 50 turns on the EVF unit 506. This function is controlled by the system controller 508.

Moreover, the image pickup apparatus 50 also has a function of turning off a power saving function (the function of reducing the electric power to be output to the image pickup unit 501, the EVF unit 506, the LCD unit 507 and the like to lower the power consumption of the image pickup apparatus 50) from the time when the slide show is started until the slide show is terminated. This function is effective for preventing the interruption of the slide show and is controlled by the system controller 508.

Moreover, the image pickup apparatus 50 is an apparatus based on Design Rule for Camera File System (DCF) (see the literature of “Design Rule for Camera File System,” version 1.0, JEIDA-49-2-1998, Japan Electronic Industry Development Association, December 1998).

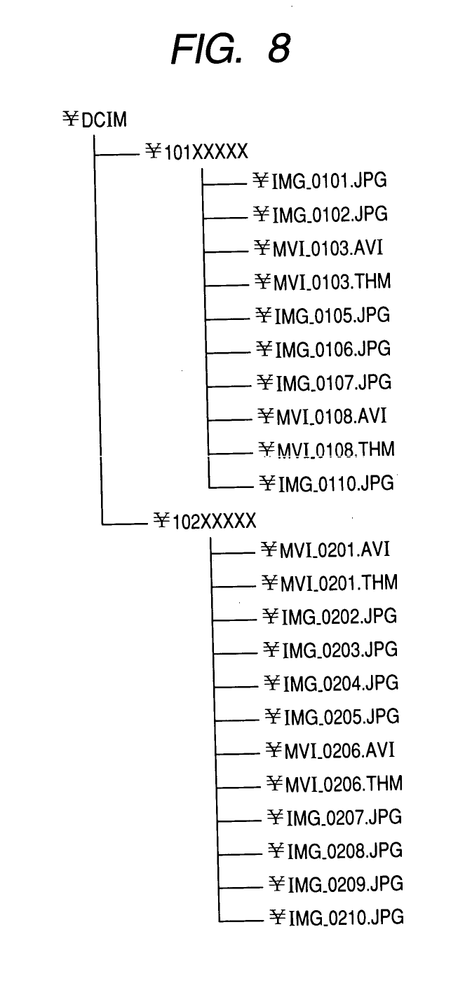

FIG. 8 is a diagram showing examples of folders and files stored in the memory card 70.

In FIG. 8, “DCIM,” “101XXXXX” and “102XXXXX” are folders. “IMG_{—}0101.JPG,” “IMG_{—}0102.JPG,” “IMG_{—}0105.JPG” to “IMG_{—}0107.JPG,” “IMG_{—}0110.JPG,” “IMG_{—}0202.JPG” to “IMG_{—}0205.JPG,” and “IMG_{—}0207.JPG” to “IMG_{—}0210.JPG” are files including still image data. “MVI_{—}0103.AVI,” “MVI_{—}0108.AVI,” “MVI_{—}0201.AVI” and “MVI_{—}0206.AVI” are files including moving image data. “MVI_{—}0103.THM,” “MVI_{—}0108.THM,” “MVI_{—}0201.THM” and “MVI_{—}0206.THM” are files including thumbnail images corresponding to “MVI_{—}0103.AVI,” “MVI_{—}0108.AVI,” “MVI_{—}0201.AVI” and “MVI_{—}0206.AVI.”

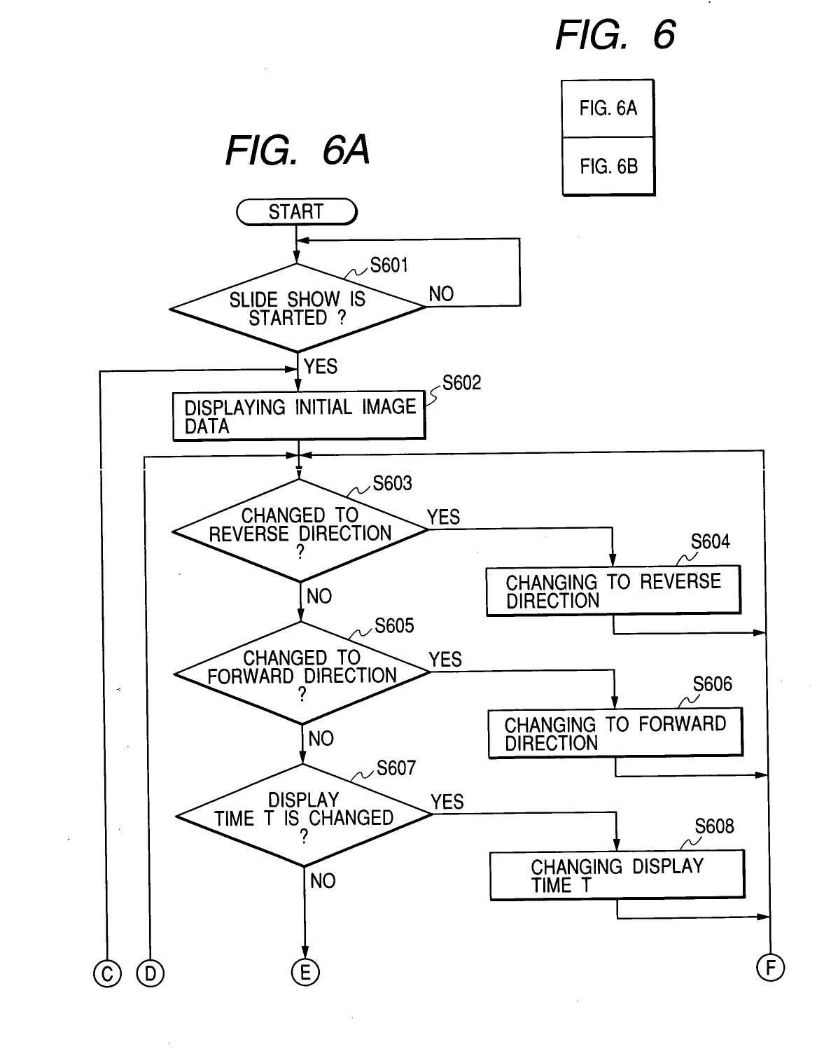

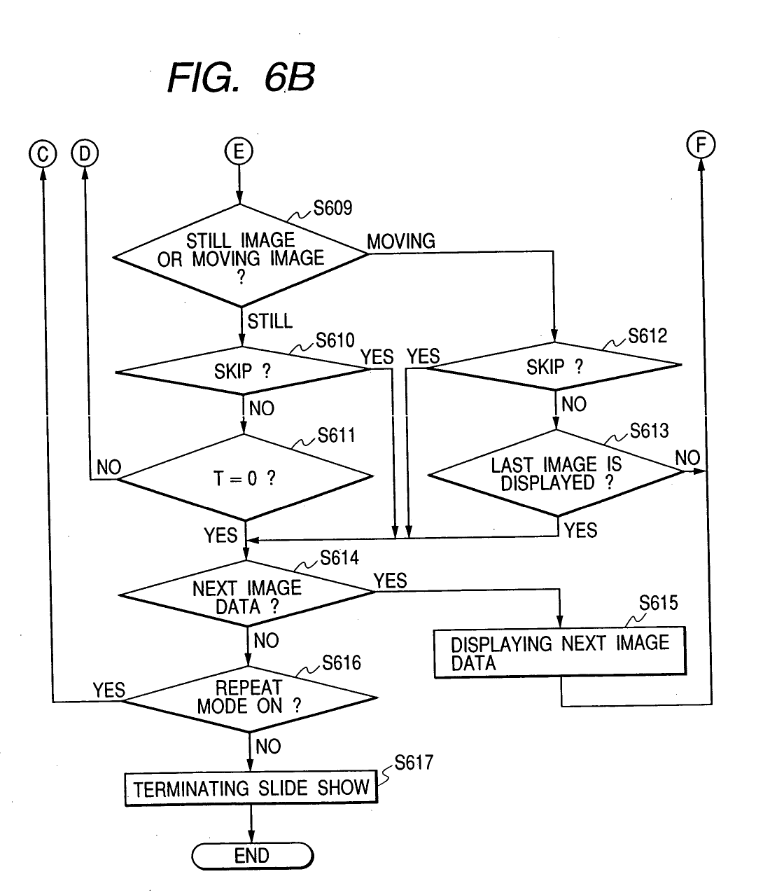

FIGS. 6A and 6B are flowcharts illustrating a processing procedure of the slide show being one of the image display functions of the image pickup apparatus 50 of the second embodiment. The slide show of the image pickup apparatus 50 is a function, which can be executed when the LCD unit 507 is on.

At Step S601, the system controller 508 judges whether a user instructs the start of the slide show or not. When the system controller 508 detects the instruction of the start of the slide show, the system controller 508 proceeds to Step S602.

At Step S602, the system controller 508 selects an image file including the image data to be displayed initially, and requests the memory card interface 504 to read the selected image file. Incidentally, the initial image data is suitably selected according to the settings of a display image and a display direction. When the initial image data is still image data, the system controller 508 starts the countdown of the presently selected display time T. The memory card interface 504 reads the image file requested by the system controller 508 from the memory card 70, and outputs the read image file to the still image processing unit 502 or the moving image processing unit 503. When the initial image data is still image data, the still image processing unit 502 decodes the still image data in the image file, and outputs the decoded still image data to the LCD unit 507 and the analog interface 505. Moreover, the still image processing unit 502 superimposes the information indicating the display time T, which is now in countdown, on the still image data. On the other hand, when the initial image data is moving image data, the moving image processing unit 503 decodes the moving image data in the image file, and outputs the decoded moving image data to the LCD unit 507 and the analog interface 505. Moreover, the moving image processing unit 503 superimposes the information indicating the total display time and the displayed time of the moving image data, on the decoded moving image data. The LCD unit 507 displays the still image data output from the still image processing unit 502 or the moving image data output form the moving image data processing unit 503. The analog interface 505 converts the still image data output from the still image processing unit 502 or the moving image data output from the moving image processing unit 503 to an analog video signal. When the display apparatus 60 is connected to the analog interface 505, the display apparatus 60 can display the analog image signal output from the analog interface 505.

At Step S603, the system controller 508 judges whether the left button B58 is depressed or not. When the system controller 508 detects that the left button B58 is depressed, the system controller 508 proceeds to Step S604. In the other cases, the system controller 508 proceeds to Step S605.

At Step S604, the system controller 508 changes the display direction to the reverse direction, and stores the fact that the display direction is changed to the reverse direction in the memory 510.

At Step S605, the system controller 508 judges whether the right button B57 is depressed or not. When the system controller 508 detects that the right button B57 is depressed, the system controller 508 proceeds to Step S606. In the other cases, the system controller 508 proceeds to Step S607.

At Step S606, the system controller 508 changes the display direction to the forward direction, and stores the fact that the display direction is changed to the forward direction in the memory 510.

At Step S607, the system controller 508 judges whether the up button B55 is depressed or not. When the system controller 508 detects that the up button B55 is depressed, the system controller 508 proceeds to Step S608. In the other cases, the system controller 508 proceeds to Step S609.

At Step S608, the system controller 508 changes the display time T to the next larger value, and stores the changed display time T in the memory 510. For example, when the display time T is three seconds, the system controller 508 changes the display time T from three seconds to five seconds.

At Step S609, the system controller 508 judges the classification of the image data displayed on the LCD unit 507 and the display apparatus 60. When the image data displayed on the LCD unit 507 and the display apparatus 60 is still image data, the system controller 508 proceeds to Step S610. When the image data displayed on the LCD unit 507 and the display apparatus 60 is moving data, the system controller 508 proceeds to Step S612.

At Step S610, the system controller 508 judges whether the down button B56 is depressed or not. When the system controller 508 detects that the down button B56 is depressed, the system controller 508 proceeds to Step S614. In the other cases, the system controller 508 proceeds to Step 611. When the system controller 508 detects that the down button B56 is depressed, the system controller 508 stops the display of the still image data, and skips to the next image data.

At Step S611, the system controller 508 judges whether the display time T reaches zero or not. When the system controller 508 detects that the display time T reaches zero, the system controller 508 proceeds to Step S614. In the other cases, the system controller 508 proceeds to Step S603.

At Step S612, the system controller 508 judges whether the down button B56 is depressed or not. When the system controller 508 detects that the down button B56 is depressed, the system controller 508 proceeds to Step S614. In the other cases, the system controller 508 proceeds to Step S613. When the system controller 508 detects that the down button B56 is depressed, the system controller 508 stops the display of the moving image data, and skips to the next imaged data.

At Step S613, the system controller 508 judges whether the moving image data is displayed up to the end thereof or not. When the moving image data is displayed up to the end thereof, the system controller 508 proceeds to Step S614. When the moving image data is not displayed yet up to the end thereof yet, the system controller 508 proceeds to Step S603. In such a way, in the slide show of the second embodiment, the system controller 508 displays the moving image data up to the end thereof unless the system controller 508 detects any depression of the down button B56.

At Step S614, the system controller 508 judges whether the image data to be displayed next exists in the memory card 70 or not. When the next image data exists, the system controller 508 proceeds to Step S615. When the next image data does not exist (when all of the images to be displayed have been displayed), the system controller 508 proceeds to Step S616. When “Display Image” is set to “All of the Images,” the system controller 508 proceeds to Step S616 after the system controller 508 makes all of the image data in the memory card 70 be displayed. Moreover, when “Display Image” is set to “Folder,” the system controller 508 proceeds to Step S616 after the system controller 508 makes all of the image data in the folder selected by the user be displayed.

At Step S615, the system controller 508 selects the image file including the next image data, and requests the memory card interface 504 to read the selected image file. Incidentally, the next image data is suitably selected according to the settings of a display image and a display direction. When the next image data is still image data, the system controller 508 starts the countdown of the presently selected display time T. The memory card interface 504 reads the image file requested by the system controller 508 from the memory card 70, and outputs the read image file to the still image processing unit 502 or the moving unit processing unit 503. When the next image data is still image data, the still image processing unit 502 decodes the still image data in the image file, and outputs the decoded still image data to the LCD unit 507 and the analog interface 505. Moreover, the still image processing unit 502 superimposes the information indicating the display time T which is now being counted down, on the decoded still image data. On the other hand, when the next image data is moving image data, the moving image data processing unit 503 decodes the moving image data in the image file, and outputs the decoded moving image data to the LCD unit 507 and the analog interface 505. Moreover, the moving image processing unit 503 superimposes the information indicating the total display time and the displayed time of the moving image data, on the decoded moving image data. The LCD unit 507 displays the still image data output from the still image processing unit 502, or the moving image data output from the moving image processing unit 503. The analog interface 505 converts the still image data output from the still image processing unit 502 or the moving image data output from the moving image processing unit 503 to an analog image signal. When the display apparatus 60 is connected to the analog interface 505, the display apparatus 60 can display the analog video signal output from the analog interface 505 thereon.

At Step S616, the system controller 508 judges whether the repeat mode is on or not. When the repeat mode is on, the system controller 508 proceeds to Step S602. When the repeat mode is off, the system controller 508 proceeds to Step S617. When the repeat mode is on, the system controller 508 starts the display from initial image data.

At Step S617, the system controller 508 automatically terminates the slide show.

Incidentally, at each step, the system controller 508 judges whether the menu button B54 is depressed or not. Then, when the system controller 508 detects that the menu button B54 is depressed, the system controller 508 terminates the slide show.

As described above, according to the slide show of the image pickup apparatus 50, it is possible to display automatically the next image data when the down button B56 is depressed during the display of moving image data. Moreover, it is also possible to display the moving data up to the end thereof when the down button B56 is not depressed during the display of the moving image data.

Moreover, according to the slide show of the image pickup apparatus 50, it is possible to display automatically the next image data when the down button B56 is depressed during the display of still image data. Moreover, it is also possible to continue to display the still image data until the display time T elapses when the down button B56 is not depressed during the display of the still image data.

Moreover, according to the slide show of the image pickup apparatus 50, it is possible to change the display direction of the image data in the memory card even when the slide show is being performed. Consequently, the slide show can be made to be more easy to use.

Moreover, according to the slide show of the image pickup apparatus 50, it is possible to change the display time T even when the slide show is being performed. Consequently, the slide show can be made to be more easy to use.

Moreover, according to the slide show of the image pickup apparatus 50, it is also possible to display the information indicating the display time T which is now counted down when still image data is being displayed. Consequently, it is possible to inform a user of the remaining time of the display time T plainly.

Moreover, according to the slide show of the image pickup device 50, it is also possible to display the information indicating the total display time and the displayed time of moving image data when the moving image data is being displayed. Consequently, it is possible to inform a user of the remaining time of the moving image data plainly.

### Third Embodiment

The slide show of the second embodiment can be modified to have an image display function of reproducing continuously all of the image data (including still image data and moving image data) and the sound data in the memory card 70 in the forward direction or the reverse direction. In this case, the image pickup apparatus 50 may process the sound data like the moving image data. That is, the image pickup apparatus 50 may display the information indicating that the sound data is being output on the LCD unit 507 while the image pickup apparatus 50 continues to output the sounds reproduced from the sound data until the down button B56 is depressed.

Many widely different embodiments of the present invention may be constructed without departing from the spirit and scope of the present invention. It should be understood that the present invention is not limited to the specific embodiments described in the specification, except as defined in the appended claims.

What is claimed is:

1. An image processing apparatus having a function of reproducing automatically a still image and a part of a moving image at every predetermined reproduction time, said apparatus comprising:
reproducing means for reproducing the remaining part of the moving image when reproduction of the moving image is instructed while the part of the moving image is being reproduced.

2. An image processing apparatus according to claim 1, wherein the function subjects to a still image and a moving image in a storage medium.

3. An image processing apparatus according to claim 1, wherein the function subjects to a still image and a moving image in a group.

4. An image processing apparatus according to any one of claims 1 to 3, wherein said image processing apparatus is an image pickup apparatus.

5. An image processing method comprising the steps of:
reproducing automatically a still image and a part of a moving image at every predetermined reproduction time; and
reproducing also the remaining part of the moving image when reproduction of the moving image is instructed while the part of the moving image is being reproduced.

6. A recording medium recording a program for executing an image processing method, said image processing method comprising the steps of:
reproducing automatically a still image and a part of a moving image at every predetermined reproduction time; and
reproducing also the remaining part of the moving image when reproduction of the moving image is instructed while the part of the moving image is being reproduced.

7. An image processing apparatus having a function of reproducing automatically a still image and a part of a moving image at every predetermined reproduction time, said apparatus comprising:
reproducing means for reproducing the moving image from an initial part thereof when reproduction of the moving image is instructed while the part of the moving image is being reproduced.

8. An image processing apparatus according to claim 7, wherein the function subjects to a still image and a moving image in a storage medium.

9. An image processing apparatus according to claim 7, wherein the function subjects to a still image and a moving image in a group.

10. An image processing apparatus according to any one of claims 7 to 9, wherein said image processing apparatus is an image pickup apparatus.

11. An image processing method comprising the steps of:
reproducing automatically a still image and a part of a moving image at every predetermined reproduction time; and
reproducing the moving image from an initial part thereof when reproduction of the moving image is instructed while the part of the moving image is being reproduced.

12. A recording medium recording a program for executing an image processing method, said image processing method comprising the steps of:
reproducing automatically a still image and a part of a moving image at every predetermined reproduction time; and
reproducing the moving image from an initial part thereof when reproduction of the moving image is instructed while the part of the moving image is being reproduced.
